(19) United States
(12) Patent Application Publication
(10) Pub. No.: US 2021/0157626 A1
(43) Pub. Date: May 27, 2021

(54) PRIORITIZING BOOTING OF VIRTUAL EXECUTION ENVIRONMENTS

(71) Applicant: Intel Corporation, Santa Clara, CA (US)

(72) Inventors: Amruta MISRA, Bangalore (IN); Chris MACNAMARA, Limerick (IE); John J. BROWNE, Limerick (IE); Liang MA, Shannon (IE); Shobhi JAIN, Shannon (IE); David HUNT, Meelick (IE)

(21) Appl. No.: 17/165,694

(22) Filed: Feb. 2, 2021

(30) Foreign Application Priority Data
Dec. 26, 2020 (IN) 202041056500

(51) Int. Cl. G06F 9/455; G06F 9/50; G06F 9/4401; H04L 12/24

(52) U.S. Cl. CPC G06F 9/45558; G06F 9/5077; G06F 2009/4557; H04L 41/5003; G06F 2009/45575; G06F 9/4401

(57) ABSTRACT

Examples described herein relate to circuitry to boot a virtualized execution environment (VEE) by use of system resources, wherein the system resources are allocated based on a priority level of the VEE. In some examples, the circuitry to boot a VEE by use of system resources is to access an identification of system resources to use to boot the VEE and priority level of the VEE from stored data. In some examples, the priority level of the VEE is based on a service level agreement (SLA), service level objective (SLO), or class of service (COS) that identifies boot time of the VEE. In some examples, the circuitry is to boot a VEE by use of system resources, wherein the system resources are allocated based on a priority level of the VEE and also based on a number of VEEs that boot concurrently.

### RELATED APPLICATION

The application claims priority from Indian provisional patent application number 202041056500, filed Dec. 26, 2020 in the Indian Patent Office. The contents of the Indian provisional patent application number 202041056500 are incorporated by reference in its entirety.

### DESCRIPTION

Virtual desktop infrastructure (VDI) provides for hosting of desktop environments on a server in a datacenter or edge network element. Backend desktop environments can run within virtual machines (VMs) and images and content can be delivered to client device over a network. In some cases, multitudes of VDIs can be launched at about the same time, which amounts to a so-called VDI boot storm. A VDI boot storm can include booting of multitudes of VMs to provide execution environments for VDIs. During boot-up of a VM, computing resources (e.g., CPU, memory, and/or network) are used and insufficient computing resources can lead to a longer boot time of some VMs. For example, if end users log into their VDI sessions at about the same time of the day, VDI and corresponding VM boot can be slow to complete due to resource unavailability and contention over computing resources. For example, a network can be overwhelmed with storage requests (e.g., Input/Output Operations Per Second (IOPS)) at such a level that VM boot-up times and service are unacceptably slow to users.

In a known solution, after a system is booted, a computing configuration is applied to allocate computing resources for booting of an integer n number of VMs. However, if more than n number of VMs are requested to be booted, VM boot time can increase as the computing resources available can slow down to unacceptable levels.

### BRIEF DESCRIPTION OF THE DRAWINGS

FIG. 1 depicts an example system.

FIG. 2 depicts an example operation.

FIG. 3 depicts an example process.

FIG. 4 depicts results of experiments.

FIG. 5 depicts an example system.

FIG. 6 depicts an example environment.

### DETAILED DESCRIPTION

Various embodiments provide for allocation of system resources to a virtualized execution environment (VEE) such as a VM or container at least during a time to boot the VEE. System resources can include one or more of: core frequency level during VEE boot, uncore frequency level during VEE boot and potentially after VEE boot, numbers of threads that execute a VEE during boot, numbers of virtual processors (e.g., virtual centralized processing unit (vCPU)) that execute a VEE during boot, amount of memory allocated for use during boot of the VEE, amount of storage allocated for use during boot of the VEE, device interface (e.g., peripheral component interconnect express (PCIe)) bandwidth during boot of the VEE, or power available to a core or uncore during boot of the VEE. For example, a thread can include a sequence of executable instructions. For example, a virtual processor can represent a share of a physical CPU (e.g., physical core, or virtual cores (e.g., hyper threads) within a core) that is assigned to a particular VEE.

Various embodiments prioritize boots of certain VEEs that boot simultaneously or at an overlapping time as other VEEs. For example, certain VEEs can be assigned a priority designation and various embodiments prioritize booting priority designated VEEs by assigning system resources at least during boot of the priority designated VEEs so that the priority designated VEEs receive sufficient resources to complete boot in accordance with applicable boot time requirements. Non-priority designated VEEs that are executing can be migrated to other resources to provide sufficient system resources during the boot of the priority designated VEEs. For example, sufficient system resources for boot of a priority VEE can be identified as particular levels of system resources that are to be allocated during boot of a priority VEE. In some examples, multiple levels of priority can be available to assign to a VEE and various system resources can be allocated to boot the VEE based on its priority level. For example, a VEE can have an associated service level agreement (SLA), service level objective (SLO), or class of service (COS or CLOS) and the SLA, SLO, COS, or CLOS can indicate a time to boot the VEE or indicate a relative priority level of the VEE. Various embodiments can prioritize boot and or execution of VEEs based on applicable SLA, SLO, COS, or CLOS. Various embodiments can track system resources and allocate system resources for VEE boot to comply with applicable SLA, SLO, COS, or CLOS.

Various embodiments can potentially reduce the boot time of VEEs and provide faster recovery time of services after VEE boot, faster response time to user login and availability of edge services (e.g., at a Mobile Edge Compute network element (MEC)). Various embodiments can potentially provide substantial improvement to VEE and application boot time and address boot delays during boot storm for VDI customers. Various embodiments can mitigate or reduce VEE boot stalls in data centers or edge network servers.

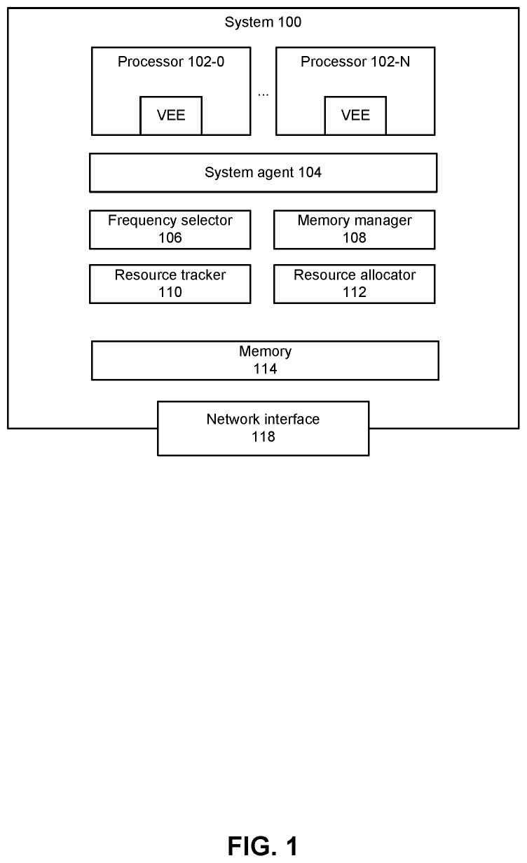

Description next turns to an example environment in which some embodiments can be executed. FIG. 1 depicts an example system. The system can be implemented as part of a server, rack of servers, computing platform, or others. In some examples, processors 102-0 to 102-N can include one or more of: a central processing unit (CPU) core, graphics processing unit (GPU), field programmable gate array (FPGA), or application specific integrated circuit (ASIC). In some examples, a core can be sold or designed by Intel®, ARM®, AMD®, Qualcomm®, IBM®, Texas Instruments®, among others. Various embodiments of any of processors 102-0 to 102-N can include an XPU, where an XPU can include at least to: a CPU, a graphics processing unit (GPU), general purpose GPU (GPGPU), or other processing units (e.g., accelerator).

Any of processors 102-0 to 102-N can execute an operating system (OS), driver, applications, and/or a virtualized execution environments (VEEs). In some examples, an OS can include Linux®, Windows® Server, FreeBSD®, Android®, MacOS®, iOS®, or any other operating system. A driver can provide configuration and use of any device such as network interface (NIC) 118.

An uncore or system agent 104 can include or more of a memory controller, a shared cache (e.g., last level cache (LLC)), a cache coherency manager, arithmetic logic units, floating point units, core or processor interconnects, Caching/Home Agent (CHA), or bus or link controllers. System agent 104 can provide one or more of: direct memory access (DMA) engine connection, non-cached coherent master connection, data cache coherency between cores and arbitrates cache requests, or Advanced Microcontroller Bus Architecture (AMBA) capabilities.

Memory 114 can include any type of volatile memory, non-volatile memory, or persistent memory. Network interface 118 can provide communication with other servers through a local network in a rack, data center, or with servers in other data centers or edge networks. Other hardware and software resources described herein can be used.

Various embodiments provide for acceleration and prioritization of booting of VEEs on cores by identifying system resources specific to VEE boot and allocating resources to booting VEEs. For example, frequency selector 106 and memory manager 108 can allocate resources to boot a VEE in accordance with various embodiments.

Frequency selector 106 can provide an interface to a hypervisor, orchestrator, or administrator to define priority of a core and control power distribution among cores. In some examples, frequency selector 106 can allow some cores to run at higher frequencies than frequencies of operation of other cores. For example, frequency selector 106 can increase frequency of operation of some cores while reducing a frequency of operation of other cores. In some examples, a device driver can be accessed to specify which cores operate at a boosted or higher frequency for an amount of time such as during VEE boot. In some examples, frequency selector 106 can utilize Intel® Speed Select Technology Core Power (SST-CP), Intel® Turbo Boost, or AMD Turbo Core technologies.

For example, memory manager 108 can allow a hypervisor, orchestrator, or administrator to control memory bandwidth allocation to control memory bandwidth distribution across executing VEEs or applications as well as an amount of cache (e.g., L1, L2, L3, or LLC) or volatile memory (e.g., memory 114) allocated to a booting VEE. Memory bandwidth can be a rate at which data can be read from or stored into a memory or storage device. In some examples, memory manager 108 can utilize memory bandwidth allocation (MBA) technology and/or Intel® Resource Director Technology (RDT) cache allocation technology (CAT). For example, MBA can provide control over memory bandwidth available to workloads. Memory bandwidth can represent a rate at which data can be read from or stored into a memory device or storage device by a processor. For example, CAT can allow an operating system (OS), hypervisor, or virtual machine manager (VMM) to control allocation of a cache (e.g., last level cache (LLC)) by pinning or exclusively allocating cache lines of the cache for use at least during a VEE boot. Some embodiments can utilize AMD Platform quality of service (QoS) to control memory bandwidth distribution across executing VEEs or applications as well as an amount of cache (e.g., L1, L2, L3, or LLC) or volatile memory (e.g., memory 114) allocated to a booting VEE as well as other resources.

Various embodiments use resource tracker 110 and resource allocator 112 to manage resources allocated to a VEE during its boot. Resource tracker 110 can track system resources and parameters during booting of one or more VEE such as core frequency, uncore frequency, memory bandwidth, device interface bandwidth (e.g., peripheral component interconnect express (PCIe)), rate of IOPS, and so forth. Resource tracker 110 can also track boot time for one or more VEEs to assist with determination if VEE boot time of an SLA is complied with. In some examples, resource tracker 110 can be implemented as a collection agent such as collectD, Telegraf, or Node Exportor. Resource usage can be sent to a management and orchestration control systems to indicate resource usage and available resources for VEE boot as well as VEE boot times.

Resource allocator 112 can receive resource utilization information from resource tracker 110, and allocate sufficient resources for use during a VEE boot. For example, resources allocated to a VEE during boot can include one or more of: core frequency level during boot, uncore frequency level during boot and potentially after boot, numbers of threads that execute a VEE during boot, numbers of virtual processor (e.g., virtual centralized processing unit (vCPU)) that execute a VEE during boot, amount of memory allocated for use during boot of the VEE, amount of storage allocated for use during boot of the VEE, power available to a core or uncore, or others. For example, if a booting VEE is a priority VEE, then resource allocator 112 can allocate sufficient resources to boot the VEE in accordance with its boot time requirement. For example, if a booting VEE is a normal priority VEE or does not have a priority attached to it, resource allocator 112 can apply best efforts to boot the VEE using available resources or increase one or more resources such as core frequency to potentially reduce a time to boot the VEE. In some examples, resource allocator 112 can be part of a Virtualized Infrastructure Manager (VIM) layer consistent with European Telecommunications Standards Institute (ETSI) Network Function Virtualization (NFV) Management and Orchestration (MANO); part of a management software stack such as Kubernetes, OpenStack, or VMware vSphere; or integrated into an software defined networking (SDN) controller or load balancer management stack.

For example, if a booting VEE has a priority attached to it such as to meet a certain boot time in an SLA, resource allocator 112 can attempt to allocate resources to attempt to reduce a time to boot the VEE. For example, resource allocator 112 can use frequency selector 106 to increase a frequency of operation or power available to a core that boots the VEE. Frequency selector 106 can place one or more cores in offline or lower power mode so that the core that boots the VEE can run at a higher frequency. Frequency selector 106 can increase a frequency of system agent 104 to reduce boot time of the VEE. For example, increasing the frequency of system agent 104 can reduce VEE boot time, in some examples. In some examples, memory manager 108 can allocate more memory bandwidth or cache space to the core that is to boot the priority VEE. If bandwidth is not available, then memory manager 108 can reduce the memory bandwidth available to already booted VEEs, whether normal priority or not. If there is a limit on available resources to boot a priority VEE, resource allocator 112 can prioritize resource allocation to the priority VEE in an order such as: increase frequency of a core that boots the VEE as a first priority and attempt to increase uncore or system frequency as a second priority.

Various non-limiting examples of VEE boot are described next. For example, VEE boot can be completed at any of: an operating system (OS) executing as part of a VEE is running or query-able to run applications; an OS responds to communications from other devices or software; an opened connectivity socket or command line socket by the VEE (e.g., with a NIC or load balancer); VEE login prompt is available so that an end user can login (e.g., session ID and password appears on a system administrator's machine); or a hypervisor (e.g., Xen or Vcenter (resource manager)) that visually identifies a state of a VEE as running.

According to various embodiments, resources for an integer X number of VEEs can be allocated for VEE boot so that the VEEs boot concurrently. Concurrent VEE boot can include multiple VEEs booting at any stage of boot at an overlapping instant of time even if the VEEs do not start booting at the same time. VEEs can boot on the same CPU, same server but different CPUs, same rack of servers or on disaggregated processor resources, where the disaggregated processor resources form a composite node and the processor resources are different CPUs, potentially in different servers, or different racks of servers. In a situation where X+y number of VEEs attempt to boot, a priority level of the y number of VEEs can be used to determine which system resources are allocated to boot the y number of VEEs. For example, for a high priority level VEE among the y number of VEEs, system resources can be allocated to boot at least the high priority level VEEs. In some cases, certain cores can be allocated or reserved for use to boot high priority VEEs. VEEs that execute on such cores, after boot, can be migrated to other cores for execution and allow such cores to be used at least to boot other high priority VEEs. In some examples, if a lower priority VEE executes on a core allocated to boot VEEs, the low priority VEE can be migrated to execute on another core after boot, such as a core operating at lower frequency or lower power. In some examples, for cores with boosted frequency of operation (e.g., Turbo Boost or Turbo Core), a frequency of a core can be reduced after VEE boot and during execution of the VEE.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux®, Windows® Server, VMware ESXi, and other operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

For example, applications can execute on processors 102-0 to 102-N and in a VEE. An application can include a service, microservice, cloud native microservice, workload, or software. An application can include a VDI. Any application can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in ETSI specifications or Open Source NFV MANO from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

Various examples described herein can perform an application composed of microservices, where each microservice runs in its own process and communicates using protocols (e.g., a Hypertext Transfer Protocol (HTTP) resource application program interface (API), message service, remote procedure calls (RPC), or Google RPC (gRPC)). Microservices can be independently deployed using centralized management of these services. The management system may be written in different programming languages and use different data storage technologies. A microservice can be characterized by one or more of: use of interfaces to independently deployable services (e.g., API, RPC, gRPC), polyglot programming (e.g., code written in multiple languages to capture additional functionality and efficiency not available in a single language), or container or virtual machine deployment, and decentralized continuous microservice delivery.

Various examples can also apply to services booting on bare metal servers. A bare metal server can host a single tenant or consumer and its VEEs. For example, services can include applications, network stack services (e.g., Linux network stack services), or microservices. For example, for a sequence or chain of services, where completion of a prior service is a condition to starting a subsequent service, booting such prior service can be given priority treatment and allocation of resources to reduce boot time of such service. Booting such prior service may lead to faster completion of the service and reduce a time to complete the sequence or chain. Various example of services chains or service sequences include DPDK-based applications such as memory allocation, hash table access followed by lookup table access.

Various examples can apply to booting of VEEs on another core, CPU, or server after migration, including live migration. In some examples, after a VEE migrates, the VEE can be re-booted. For example, VEEs can be migration because of a power outage, renewable energy optimization, planned maintenance, or other reasons. For example, an orchestrator (e.g., VMware ESXi, Xen, MSFT Azure, Amazon Web Services (AWS)) can determine when to migrate a VEE to execute on another core. A kernel scheduler (e.g., Linux task scheduler, Windows task scheduler, etc.) could determine to change a VEE to execute on a different core of a CPU or different CPU. Various examples can be used to determine whether and which CPU or server to migrate a VEE to based on available resources indicated by resource tracker 110. Accordingly, multiple different servers can utilize one or more replicas of resource tracker 110 to indicate available resources to an orchestrator or kernel scheduler so that the orchestrator or kernel scheduler can determine which CPU core or server has sufficient resources to boot the VEE rapidly enough or at least sufficient resources specified in an applicable SLA, SLO, or COS. The orchestrator or kernel scheduler can select a CPU core or server to migrate the VEE to based on the CPU core or server that have sufficient resources to boot the VEE based on its applicable SLA, SLO or COS. In some cases, if an orchestrator or kernel scheduler determine that boot objectives cannot be met on another CPU core or server, the orchestrator or kernel scheduler can determine not to migrate the VEE.

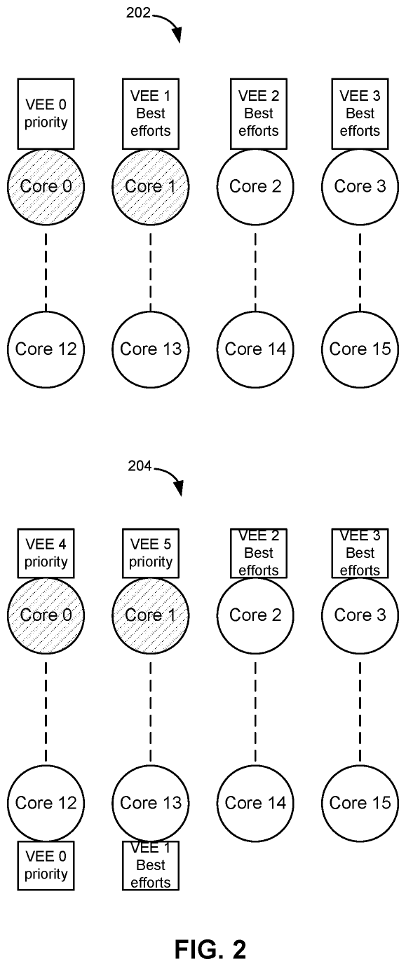

FIG. 2 depicts an example operation. In scenario 202, VEE0 receives priority resources at least during boot to attempt to reduce time to boot. VEE1 is identified to utilize best efforts resources during boot. VEE2 and VEE3 receive best efforts resources at least during boot as the time to boot may not be subject to an SLA or SLO. In scenario 202, cores 0 and 1 are allocated higher frequency and power and can be allocated to boot priority VEEs whereas cores 2-15 can operate at lower frequency and power than that of cores 0 and 1. VEE0 is allocated to boot using core 0 whereas VEE1 is executing on core 1 in this example.

In scenario 204, VEE0 has booted and VEE4 and VEE5 are to boot. VEE0 can be migrated to core 12 for execution and VEE1 can be migrated from higher frequency core 1 to core 13 for execution. This frees cores 0 and 1 to boot other VEEs. VEE4 and VEE5 can be allocated to boot on respective cores 0 and 1.

Note that in some scenarios, a CPU and its cores or CPUs and their cores can be dedicated to boot VEEs whereas some other CPUs are dedicated to execute VEEs during run time and after boot. A farm or rack of servers could be allocated to boot VEEs whereas another farm or rack of servers could be allocated to boot VEEs and another farm or rack of servers can be allocated to execute VEEs after boot. In some examples, migration of a VEE can occur from a core to a second core where the core and second core share a cache. VEE context and state information can be stored in the cache and available for access by the second core that boots the migrated VEE.

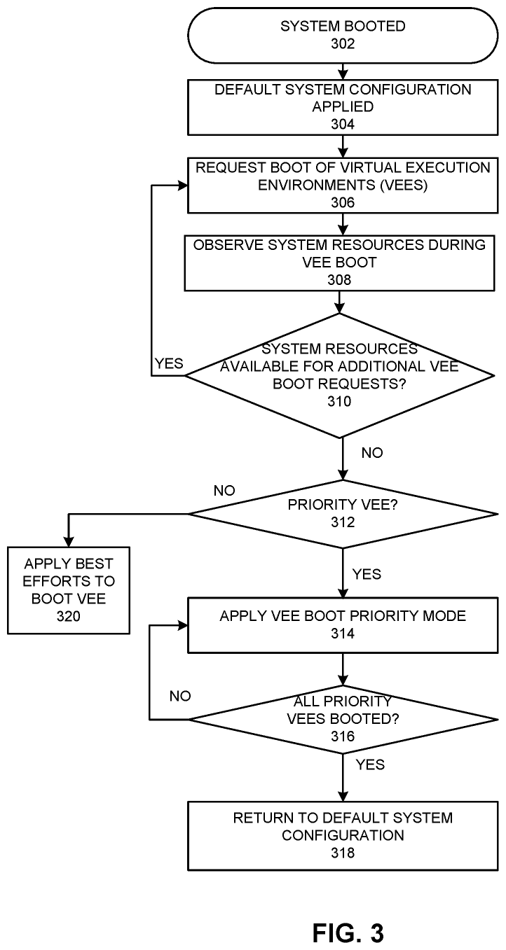

FIG. 3 depicts an example process. At 302, a system boot can occur. At 304, a system configuration can be applied that indicates resource allocation to VEEs during boot and execution. At 306, a number of VEEs can be requested to be booted on the system. For example, a system administrator can request X number of VEEs to be booted. At 308, system resources can be allocated to the booting VEEs. For example, designated core frequency, uncore frequency, memory allocation, cache allocation, device connection bandwidth, and so forth can be allocated for use to boot at least some of the X number of VEEs. At 310, a determination is made if system resources are available to boot additional VEEs. System resources can be identified to be available if additional VEEs can be expected to boot within applicable boot time requirements, if any. If system resources are available to boot additional VEEs, the process can proceed to 306 to boot the additional VEEs using default system resource configurations for VEE boot. However, if system resources are determined to not be available to boot additional VEEs, the process can proceed to 312.

At 312, a determination can be made to determine if an additional VEE that is to be booted is a priority VEE. A VEE can be considered a priority VEE if the VEE has an SLA, SLO, CLOS, or COS or a specified boot time requirement to satisfy. If the VEE is considered a priority VEE, the process can proceed to 314. If the VEE is not considered a priority VEE, the VEE can be boot using best efforts on available resources at 320.

At 314, resources can be allocated to boot the VEE according to applicable boot time requirements. Allocation of resources to a priority VEE during boot can include increase of one or more of: core frequency level during boot, uncore frequency level during boot and potentially after boot, numbers of threads that execute a VEE during boot, numbers of virtual processor (e.g., virtual centralized processing unit (vCPU)) that execute a VEE during boot, amount of memory allocated for use during boot of the VEE, amount of storage allocated for use during boot of the VEE, device interface bandwidth (e.g., to a NIC), or power available to a core or uncore. At 316, a determination can be made if all VEEs requested to be booted in 310 have booted. If all such VEEs have not booted, the process can return to 314. If all such VEEs have booted, the process can proceed to 318 to return to application of the default system configuration for booting of VEEs.

Accordingly the process of FIG. 3 can be used to increase resource allocation to VEEs that are high priority or priority to attempt VEE boot in accordance with boot time requirements while allowing non-priority VEEs to boot best efforts.

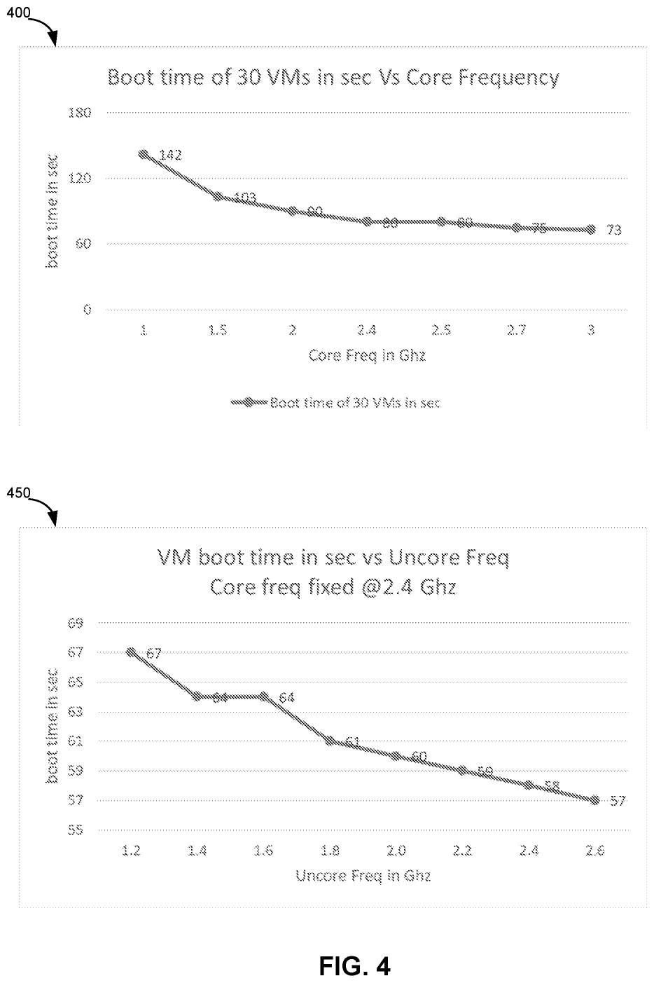

FIG. 4 depicts results of experiments. Sample results 400 show results of experiments performed using a VMware ESXi environment. The total VEE boot time improves nearly 100% when core frequency is increased by three times for a VEE booting using 4 vCPU with 8 GB RAM and 25 GB disk size.

Sample results 450 show results of experiments whereby VEE boot time depends on uncore frequency as well. For an ESXi system with 10 VMs with core frequency fixed at 2.4 Ghz, increasing the uncore frequency from 1.2 Ghz to 2.6 GHz can reduce boot time for a VEE using 4 vCPU with 8 GB RAM and 25 GB disk size.

Experimental results from frequency boosting cores used to boot VEE in a ESXi system with VEE size of 4 vCPU using 8 GB RAM, 25 GB disk size is as follows.

| System Setting | Boot Time | Core Frequency observed | |
|---|---|---|---|
| Default: 28 Cores active | 81 sec | 2.8 | Ghz |
| Boosted frequency: 8 cores offline, | 69 sec | 3.35 | Ghz |
| 20 core active | | | |

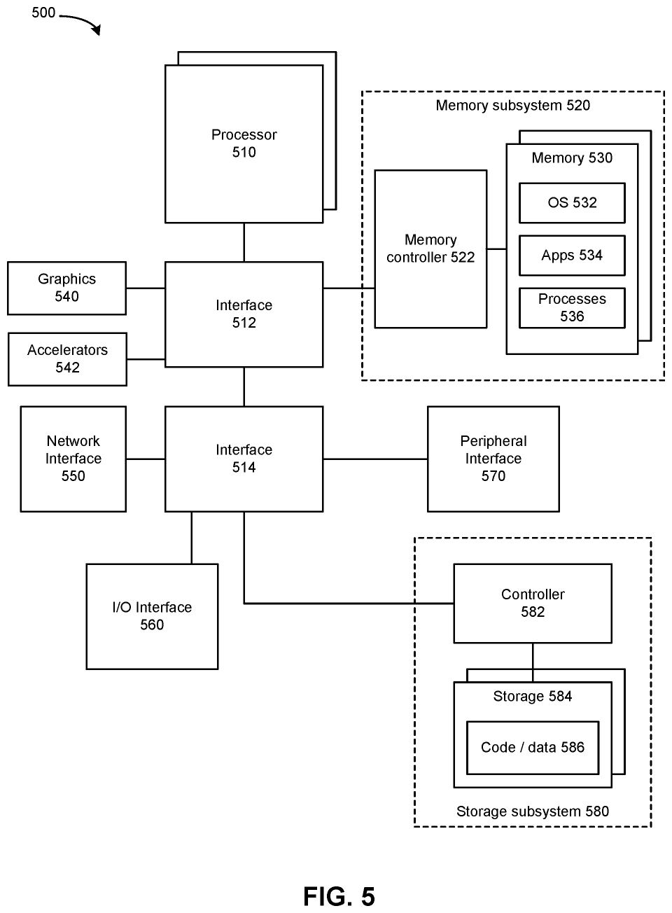

FIG. 5 depicts a system. Various embodiments of system 500 can be used to allocate resources to VEEs during boot. System 500 includes processor 510, which provides processing, operation management, and execution of instructions for system 500. Processor 510 can include any type of microprocessor, central processing unit (CPU), graphics processing unit (GPU), Accelerated Processing Unit (APU), XPU, processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that uses higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be fixed function and/or programmable offload engines that can be accessed or used by a processor 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs).

Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It can be understood that memory controller 522 could be a physical part of processor 510 or a physical part of interface 512. For example, memory controller 522 can be an integrated memory controller, integrated onto a circuit with processor 510.

While not specifically illustrated, it can be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. Various embodiments can be used in connection with network interface 550, processor 510, and memory subsystem 520.

Various embodiments of network interface 550 can include an infrastructure processing unit (IPU), data processing unit (DPU), or smartNIC. An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WI02 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), Infinity Fabric (IF), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

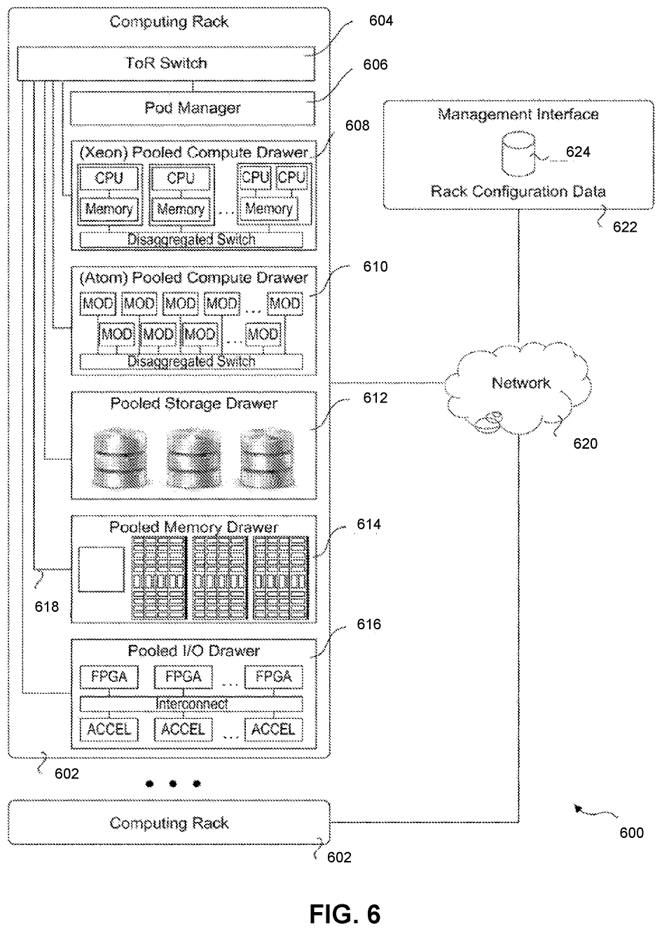

FIG. 6 depicts an environment 600 includes multiple computing racks 602, one or more including a Top of Rack (ToR) switch 604, a pod manager 606, and a plurality of pooled system drawers. Various embodiments can be used among servers in racks to attempt to increase speed of VEE boot. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 608, and Intel® ATOM™ pooled compute drawer 610, a pooled storage drawer 612, a pooled memory drawer 614, and a pooled I/O drawer 616. Any of the pooled system drawers is connected to ToR switch 604 via a high-speed link 618, such as an Ethernet link and/or a Silicon Photonics (SiPh) optical link.

Multiple of the computing racks 602 may be interconnected via their ToR switches 604 (e.g., to a pod-level switch or data center switch), as illustrated by connections to a network 620. In some embodiments, groups of computing racks 602 are managed as separate pods via pod manager(s) 606. In one embodiment, a single pod manager is used to manage all of the racks in the pod. Alternatively, distributed pod managers may be used for pod management operations.

Environment 600 further includes a management interface 622 that is used to manage various aspects of the environment. This includes managing rack configuration, with corresponding parameters stored as rack configuration data 624.

In some examples, embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

For example, various embodiments can be used for wired or wireless protocols (e.g., 3GPP Long Term Evolution (LTE) (4G) or 3GPP 5G), on-premises data centers, off-premises data centers, base station devices, sensor data sender or receiver devices (e.g., for autonomous vehicles or augmented reality applications), endpoint devices, servers, routers, edge network elements (computing elements provided physically closer to a base station or network access point than a data center), fog network elements (computing elements provided physically closer to a base station or network access point than a data center but further from an edge network), and/or hybrid data centers (e.g., data center that use virtualization, cloud and software-defined networking to deliver application workloads across physical data centers and distributed multi-cloud environments). Network or computing elements can be used in local area network (LAN), metropolitan area network (MAN), network with devices connected using optical fiber links, campus area network (CAN), or wide area network (WAN).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes an apparatus comprising: circuitry to boot a virtualized execution environment (VEE) by use of system resources, wherein the system resources are allocated based on a priority level of the VEE.

Example 2 includes any example, wherein the circuitry to boot a VEE by use of system resources is to access an identification of system resources to use to boot the VEE and priority level of the VEE from stored data.

Example 3 includes any example, wherein the system resources comprise one or more of: frequency of a core that is to boot the VEE, uncore frequency during boot of the VEE, device interface bandwidth during boot of the VEE, memory bandwidth during boot of the VEE, memory allocation during boot of the VEE, or cache allocation during boot of the VEE.

Example 4 includes any example, wherein the resources comprise a group of two or more cores, wherein at least one core among the group of two or more cores is to operate at a first frequency and at least one other core among the group of two or more cores is to operate at a second frequency, wherein the first frequency is higher than the second frequency, and wherein a core that operates at the first frequency is to boot a high priority level VEE.

Example 5 includes any example, wherein the priority level of the VEE is based on a service level agreement (SLA), service level objective (SLO), or class of service (COS) that identifies boot time of the VEE.

Example 6 includes any example, and includes circuitry to migrate the VEE, after boot, to another core for execution.

Example 7 includes any example, wherein the circuitry is to migrate a second VEE executing on a first core to a second core to permit the VEE to boot at least using the first core.

Example 8 includes any example, wherein the circuitry is to track available system resources and allocate a portion of the available system resources to boot the VEE.

Example 9 includes any example, wherein the circuitry is to boot a VEE by use of system resources, wherein the system resources are allocated based on a priority level of the VEE and also based on a number of VEEs that boot concurrently.

Example 10 includes any example, wherein boot concurrently comprises booting at an overlapping instant in time at any stage of boot.

Example 11 includes any example, comprising a rack with multiple servers to boot multiple VEEs.

Example 12 includes any example, comprising a composite node of resources with multiple servers to boot multiple VEEs.

Example 13 includes any example, and includes a computer-readable medium comprising instructions stored thereon, that if executed by one or more processors, cause the one or more processors to: allocate resources to boot a virtualized execution environment (VEE) based on one or more of: a priority level of the VEE or a number of VEEs that boot concurrently.

Example 14 includes any example, wherein the priority level of the VEE is based on a service level agreement (SLA), service level objective (SLO), or class of service (COS) associated with the VEE.

Example 15 includes any example, wherein the resources comprise one or more of: frequency of a core that is to boot the VEE, uncore frequency during boot of the VEE, device interface bandwidth during boot of the VEE, memory bandwidth during boot of the VEE, memory allocation during boot of the VEE, or cache allocation during boot of the VEE.

Example 16 includes any example, wherein the resources comprise a group of two or more cores, wherein at least one core among the group of two or more cores is to operate at a first frequency and at least one other core among the group of two or more cores is to operate at a second frequency, wherein the first frequency is higher than the second frequency, and wherein a core that operates at the first frequency is to boot a high priority level VEE.

Example 17 includes any example, and includes a method comprising: selecting resources to utilize to boot a virtualized execution environment (VEE) based on one or more of: a priority level of the VEE or a number of VEEs that are in a boot state.

Example 18 includes any example, wherein the priority level of the VEE is based on a service level agreement (SLA), service level objective (SLO), or class of service (COS) associated with the VEE.

Example 19 includes any example, wherein the resources comprise one or more of: frequency of a core that is to boot the VEE, uncore frequency during boot of the VEE, device interface bandwidth during boot of the VEE, memory bandwidth during boot of the VEE, memory allocation during boot of the VEE, or cache allocation during boot of the VEE.

Example 20 includes any example, wherein the resources comprise a group of two or more cores, wherein at least one core among the group of two or more cores operates at a first frequency and at least one other core among the group of two or more cores operates at a second frequency, wherein the first frequency is higher than the second frequency, and wherein a core that operates at the first frequency executes boots a high priority level VEE.

Example 21 includes any example, and includes: after boot of the VEE, migrating the VEE for execution on another processor.

What is claimed is:

1. An apparatus comprising:
circuitry to boot a virtualized execution environment (VEE) by use of system resources, wherein the system resources are allocated based on a priority level of the VEE.

2. The apparatus of claim 1, wherein the circuitry to boot a VEE by use of system resources is to access an identification of system resources to use to boot the VEE and priority level of the VEE from stored data.

3. The apparatus of claim 1, wherein the system resources comprise one or more of: frequency of a core that is to boot the VEE, uncore frequency during boot of the VEE, device interface bandwidth during boot of the VEE, memory bandwidth during boot of the VEE, memory allocation during boot of the VEE, or cache allocation during boot of the VEE.

4. The apparatus of claim 1, wherein the resources comprise a group of two or more cores, wherein at least one core among the group of two or more cores is to operate at a first frequency and at least one other core among the group of two or more cores is to operate at a second frequency, wherein the first frequency is higher than the second frequency, and wherein a core that operates at the first frequency is to boot a high priority level VEE.

5. The apparatus of claim 1, wherein the priority level of the VEE is based on a service level agreement (SLA), service level objective (SLO), or class of service (COS) that identifies boot time of the VEE.

6. The apparatus of claim 1, comprising:
circuitry to migrate the VEE, after boot, to another core for execution.

7. The apparatus of claim 1, wherein the circuitry is to migrate a second VEE executing on a first core to a second core to permit the VEE to boot at least using the first core.

8. The apparatus of claim 1, wherein the circuitry is to track available system resources and allocate a portion of the available system resources to boot the VEE.

9. The apparatus of claim 1, wherein the circuitry is to boot a VEE by use of system resources, wherein the system resources are allocated based on a priority level of the VEE and also based on a number of VEEs that boot concurrently.

10. The apparatus of claim 9, wherein boot concurrently comprises booting at an overlapping instant in time at any stage of boot.

11. The apparatus of claim 1, comprising a rack with multiple servers to boot multiple VEEs.

12. The apparatus of claim 1, comprising a composite node of resources with multiple servers to boot multiple VEEs.

13. A computer-readable medium comprising instructions stored thereon, that if executed by one or more processors, cause the one or more processors to:
allocate resources to boot a virtualized execution environment (VEE) based on one or more of: a priority level of the VEE or a number of VEEs that boot concurrently.

14. The computer-readable medium of claim 13, wherein the priority level of the VEE is based on a service level agreement (SLA), service level objective (SLO), or class of service (COS) associated with the VEE.

15. The computer-readable medium of claim 13, wherein the resources comprise one or more of: frequency of a core that is to boot the VEE, uncore frequency during boot of the VEE, device interface bandwidth during boot of the VEE, memory bandwidth during boot of the VEE, memory allocation during boot of the VEE, or cache allocation during boot of the VEE.

16. The computer-readable medium of claim 13, wherein the resources comprise a group of two or more cores, wherein at least one core among the group of two or more cores is to operate at a first frequency and at least one other core among the group of two or more cores is to operate at a second frequency, wherein the first frequency is higher than the second frequency, and wherein a core that operates at the first frequency is to boot a high priority level VEE.

17. A method comprising:
selecting resources to utilize to boot a virtualized execution environment (VEE) based on one or more of: a priority level of the VEE or a number of VEEs that are in a boot state.

18. The method of claim 17, wherein the priority level of the VEE is based on a service level agreement (SLA), service level objective (SLO), or class of service (COS) associated with the VEE.

19. The method of claim 17, wherein the resources comprise one or more of: frequency of a core that is to boot the VEE, uncore frequency during boot of the VEE, device interface bandwidth during boot of the VEE, memory bandwidth during boot of the VEE, memory allocation during boot of the VEE, or cache allocation during boot of the VEE.

20. The method of claim 17, wherein the resources comprise a group of two or more cores, wherein at least one core among the group of two or more cores operates at a first frequency and at least one other core among the group of two or more cores operates at a second frequency, wherein the first frequency is higher than the second frequency, and wherein a core that operates at the first frequency executes boots a high priority level VEE.

21. The method of claim 17, comprising: after boot of the VEE, migrating the VEE for execution on another processor.
